(19) United States
(12) Patent Application Publication
(10) Pub. No.: US 2012/0141961 A1
(43) Pub. Date: Jun. 7, 2012

(54) SYSTEM AND METHOD FOR MOTIVATING A USER BASED ON PERSONALIZED AUDIOVISUAL SEQUENCES

(75) Inventors: Rafael Mahave, San Sebastian de los Reyes (ES); Alejandro Mahave, San Sebastian de los Reyes (ES)

(73) Assignee: YUMP INTERNATIONAL, Inc., Stamford, CT (US)

(21) Appl. No.: 12/961,076

(22) Filed: Dec. 6, 2010

(51) Int. Cl. G09B 19/00

(52) U.S. Cl. 434/236

(57) ABSTRACT

A system and a method for motivating a user to achieve a goal, based on customized video sequences. The customization is performed by integrating personal elements (images, phrases, voice . . . ) in a video-base that is suitable for the goal. The user watches the customized video according to an established calendar in dependence upon the type of goal and his personal characteristics. The visual effect produces a moment of emotional impact, which is maintained in the long term by periodical visualization of modified customized videos, according to the user's progress.

### TECHNICAL FIELD OF THE INVENTION

The area that the present invention refers to is that of technologies for Motivation and Self Improvement or Personal Development.

### BACKGROUND

Along the entire history, although particularly in the last century, numerous disciplines oriented to the understanding, development and improvement of human beings have emerged. All of them have studied the origin of our behaviour and offered improvement models.

Parallel to this traditional psychology developed mainly in the 20th century—more concerned about the “patients” pathologies—, during the last 2 or 3 centuries, a series of disciplines and techniques have appeared which do not centre on the cure of mental disorders, but rather on the improvement and development of people's potential, of their “clients”. We are referring to Self Improvement, Coaching, Neuro-Linguistic Programming (NLP) and other disciplines; to new concepts such as Emotional Intelligence, Self-image . . . In this last group of disciplines and techniques, which we could group under the generic concept of “Self Improvement”, plenty of literature, schools and methodologies have been developed along this last century.

However, all the developments in this field are generally limited to books, videos and offering face-to-face courses, with a relatively limited mentality and effectiveness.

In this process of self-improvement and help in the achievement of goals, little attention has been paid—or no appropriate tools have been found—to the personalization, adapting the product to each person; and to a vital phase of the process: the follow-up for the achievement and maintenance of attained goals in the long term. Furthermore, so far no effective system has been found, a system which can maintain over time an essential part of the difficult road of attaining one's desires: motivation, that engine which guides you, keeps you going and pushes you towards achieving your goals.

For a continuous motivation is advantageous to produce changes in the individual at a level which is not merely superficial, and therefore, to obtain medium-long term results, it is essential that the invention incorporates 2 basic elements: emotion and repetition. That is, the invention has to be capable of generating a moment of strong emotional impact; but later it also has to be able of maintaining it in the long term: to periodically relive the emotional impact until the final achievement of your objective.

The methodology of continuous motivation through this invention enables to create these emotional moments of impact and after that, to maintain them in the long term (emotion and repetition). And all that is offered in a fun, easy and absolutely personalized and automated fashion.

### SUMMARY

The key elements of the present invention for continuous motivation methodology are:
small audiovisual sequences—videos—
their “manufacturing” algorithm that personalizes the video to each user
the visualization calendar: the recommended dosage
the follow-up: communication and control
evolution: mutation of the videos
   These audiovisual sequences will be also referred to as “motivational video-pills” or simply “video-pills”.

Preferably, the entire process and interaction with the user is carried out through a web platform, online and, therefore, 100% automated. As stated above, it is an object of this invention to help users achieve—and maintain over time—a level of motivation and connection with themselves and their objectives, indispensible to achieve any goal set in life (be them professional, personal, physical, relational . . . ).

It is an object of this invention to provide a system and a method of producing personalized video sequences according to the user's needs.

Another object of this invention is to provide a dosage system, or recommended administration of the video sequences, according to the user's needs.
It is a further object of this invention to provide a system and a method of following-up the user's progression.
Yet an object of this invention is to provide a system and a method of modifying produced video sequences of a user according to his progression.

There are other elements necessary for the achievement of objectives in life, besides continuous motivation and optimum mental and emotional state. For example, it is also necessary to have an action plan and to track it continuously. But this part of the process—the most “rational” part—is relatively simple and in fact, there is a plurality of tools in the market, which work as calendar of objectives, or the like, which facilitate this task.

But the real key to success to attaining goals and achieving a change of life lies, not in rational aspects, but in emotional ones. And it is in that aspect where the invention follows a methodology to generate personalized and high-impact emotions, trough the video-pills. This entails a radical differentiation from all current options, both in the market in general, and regarding existing patents.

The present invention is based on audiovisual elements, due to the fact that our brain acts in the same way: spontaneously and uncontrollably, it builds its own video sequences, often negative and emotionally “self-sabotaging”. Visualization has always been part of any method for self-improvement and human transformation. However, prior-art inventions have failed using visualization, due to the lack of a continuity and automatically personalized system.

As it was mentioned before, the basic element of motivation methodology to achieve objectives is a customized video sequence, also referred to as the “motivational video-pill” or simply “video-pill”, a product which manufacturing integrates both psychological and audiovisual elements and criteria.
It consists of a personalized audiovisual sequence, with a general duration ranging from 2 to 5 minutes. The content of these videos comprises 2 types of elements:
a Base-Video, comprising generic audiovisual elements. The selected Base Video depends only on the type of objective the user is trying to achieve.
several user's personal elements (images, texts, voice . . . , supplied or selected by the user him/herself), which are automatically integrated, forming one product: the video-pill. Some of the user's personal experiences or habits, can also be incorporated to the video-pill, by adding pre-recorded video fragments, regarding those particular situations.

The composition and production algorithm of motivational video-pills is similar to that of a cooking recipe: there are different input elements or “ingredients” (INPUT), in this case, audiovisual input, which have to be “prepared” and arranged/integrated, according to a series of CRITERIA and PRODUCTION guidelines (PROCESS), to produce the OUTPUT or final product (motivational video-pills). Besides the production algorithm, as formula for the production of the video-pill, there are other essential aspects related thereto and which form part of the invention:
An Evolution Unit, in charge of performing “mutations” of the video-pill. The video-pill is thus a dynamic element: its structure and composition algorithm are defined from the beginning, to adapt to the user's changing reality: some elements—personal elements and base-video elements—are repeated, extended or shortened. New elements are also incorporated and others are eliminated.
The Dosage Unit, in charge of the definition of a calendar and a recommended visualization frequency of the video-pill. That is, the frequency and “consumption dosage” of the video-pill are determined, in the same way as it would occur with a prescription.
The Follow-up Unit, in charge of the almost daily communication and control with each user, according to their level of connection and dosage compliance. This is always carried out in an automated and personalized manner.

Therefore, the invention applies the motivation methodology through personalized and motivational video-pills and comprises:

The video-pill itself (based on the production algorithm)

The evolution of said video-pill, in its future mutations

The recommended frequency of visualization (“dosage”)

The follow-up, communication and control of users' progress

As it has been indicated before, video-pills comprise a series of elements—be them videos, images, audio (music and voice), text/phrases, etc.—provided by the user him/herself, or by the web Platform.

The elements provided by the web Platform can be optional (to be chosen by the user) or compulsory.
The elements incorporated compulsorily to the video-pill form what is called the “Base-Video”: video common to all users and which constitutes the basic and central history of the video-pill and in which personal elements are integrated.
Base-Videos (image and music) are preferably ad-hoc filmed and produced, since they must be 100% adapted to the elements and contents which are to be included in the video-pill. However, there can also be included external audiovisual elements, from banks of videos/images, commercial films, musical production companies, etc.

According to the content and what is represented at the psychological and motivational level, the elements (personal or generic of the base-video), can be associated to:

The Starting Situation: unhappiness, conformity, lack of confidence . . .

The Decision to Change

The Dream/Objective pursued (sometimes, they can be situations which the users want to avoid or run away from)

Faith in the achievement of the Objective

A written Commitment (with oneself, with others, with one's Action Plan, with the final Accomplishment . . . )

Success or failure Beliefs (booting or limiting beliefs)

The Struggle against personal “enemies”: cowardice, insecurity, laziness, pessimism, apathy, temptations . . . It also includes harmful habits (to be abandoned or avoided) and positive habits (to be reinforced or adopted)

Elements of certain psychological exercises, such as Anchoring (NLP exercise (Neuro-Linguistic Programming), which the user does, linked to Faith in the achievement)

Success: potential situation after the achievement of the Objective

From all these psychological/motivational elements, the three basic and fundamental ones, the authentic engines of change are: the Dream, the Faith and the Commitment. These three elements are the ones which really drive people to action and enable the user to stay on the right path when facing difficult situations or motivational slumps.

### BRIEF DESCRIPTION OF THE DRAWINGS

FIG. 1A and FIG. 1B.—A flow diagram is shown broken in two for clarity. It is a flow diagram of the general process followed by the web platform user and which constitutes the basis of the methodology to be applied by the invention: selection and creation of the motivational pill or video-pill; visualization thereof; and maintenance of the impact and effect produced over time, through the Dosage Unit and the Follow-up Unit.

FIG. 2.—Breakdown and basic composition of elements of the first fragment or phase (of 3) of a video-pill: Visual effect of Identification between the user and the character in the film; Current Situation; Dream/Objective to be attained; and Decision to Change. Although there can be variations in the order and duration thereof, the elements which appear in this first fragment are all essential to attain the desired result.

FIG. 3.—Breakdown and basic composition of elements of the second fragment or phase of a video-pill: Action (start-up of the action plan and the video-pills' methodology); Commitment; Faith in the achievement; and Struggle (with one's own enemies and insecurities, alternation of success and failure).

Once more, there can be variations in the order and duration of said elements.

FIG. 4.—Breakdown and basic composition of elements of the third and last fragment or phase of a video-pill: Success (situations in which the character defeats his/her internal/external enemies); recollection of the “triad”: Dream, Faith and Commitment; and finally, return to the user through identification with the character in the film. Once more, there can be variations in the order and duration of said elements.

FIG. 5.—Basic elements which form the Dosage Unit of the video-pills (recommended video-pill visualization calendar and frequency)

FIG. 6.—Basic elements which form and determine the Follow-up Unit, in order to control and to communicate with the user, according to his/her evolution: his/her dosage compliance and his/her Action Plan compliance.

FIG. 7.—Evolution Unit for generating Mutations of the video-pill. Different aspects which form part of the evolution process over time of the video-pill production algorithm, constantly adapting to the user's situation and reality.

FIG. 8. It is a block diagram representing different functional elements according to an embodiment of the invention and their interconnections. The elements are mostly units, which represent different parts according to the invention.

FIG. 9.—Examples of integration of personal elements, in the frames of the Base-Video: examples of integration are shown in a real video sequence. It can be observed how personal elements are perfectly integrated in each frame, as integrating part of the video sequence itself

FIG. 10 Evolution of the user's Emotional State, during the 3 phases of the video-pill, according to the audiovisual criteria of the film structure (Introduction, Conflict and Resolution).

### DETAILED DESCRIPTION

After explaining the general concepts and basic operation of video-pills, as audiovisual product for the continuous motivation and achievement of personal objectives, some important aspects of said product and of the methodology for its correct application will be explained now in greater detail.

Specifically, the following aspects will be explained:
a) Basic FACTORS affecting the Video-pills' structure
b) More detailed description of the BASIC ELEMENTS which constitute the video-pill
c) Different types of Objectives and Personality Traits to focus on with video-pills: topics and TYPES OF VIDEO-PILLS
d) Description of the basic elements of the System to establish the DOSAGE recommended to the user
e) Description of basic elements of the System of FOLLOW UP, control and communication with the user
f) Evolution and mutations of the video-pill

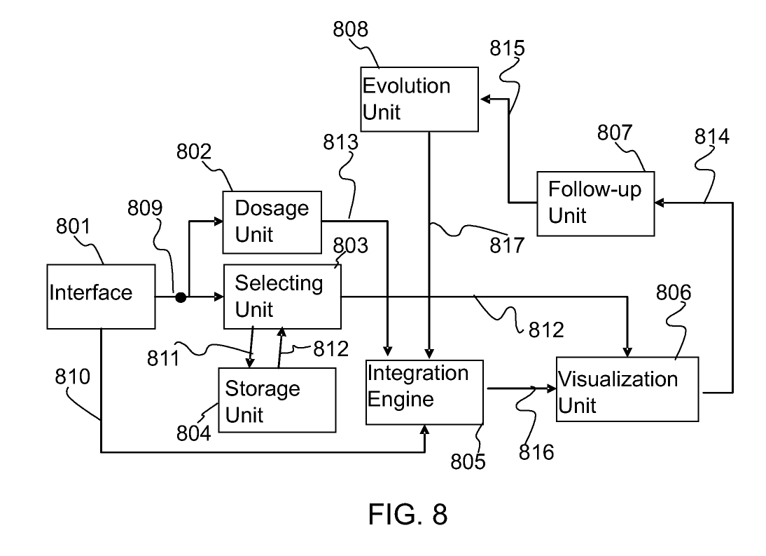

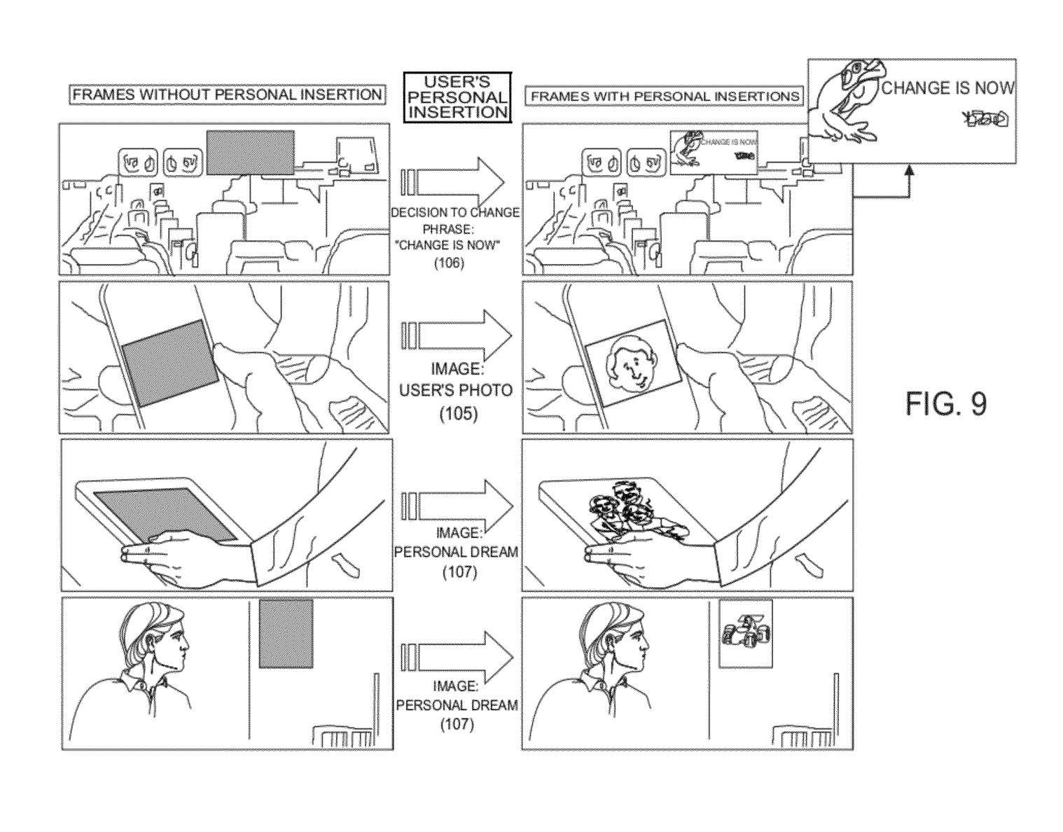

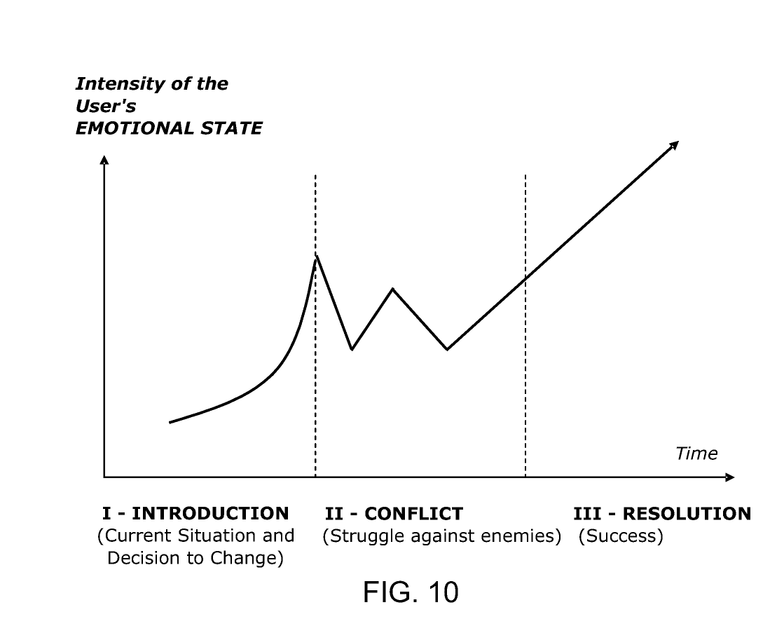

Firstly, to assist in a better understanding of the invention, reference is made to the FIG. 8. The block diagram represents different functional elements according to an embodiment of the invention and their interconnections. The elements are units which represent different parts according to the invention. There are also inputs and outputs of each unit. The main elements shown are the following.

An interface (801) that obtains data from the user, said data is needed for identifying the type of user and his goal. In this fashion, there is a first input (809) of data in connection with a type of goal and user's personal information associated with said goal, e.g. habits and experiences.

There is also a second input (810) of data regarding additional personal elements, e.g. a photography, voice messages, encouraging sentences, etc. The second input (810) is used by an Integration Engine (805) to personalize a motivational base video to produce a customized video (that is to say a video-pill) and in addition it is used by an Evolution Unit (808) to modify the customized video (816) according to the user's progress. Thus, the Evolution Unit (808) sends instructions (817) for the Integration Engine to modify the customized video (816).

On the other hand, the first input (809) initially assists in choosing and retrieving the base video (812) by means of query (811) launched by a Selecting Unit (803) to a Storage Unit (804) where a plurality of base videos are stored in. Furthermore, the first input (809) assists in setting several parameters related to a time-organization of visualizations of the customized video (816). Said function is carried out by a Dosage Unit (802) and generates a calendar (813).

A Visualization Unit (806) allows customized video to be reproduced and generates, when visualizad, a Visualization Indicator (814) is produced as a signal for checking user's compliance with the expected visualizations of the calendar (813). This signal is used by a Follow-up Unit (807) to evaluate user's progress.

The previously mentioned aspects are addressed below:

a) Basic FACTORS Affecting the Video-Pills' Structure

The final structure of each video-pill is determined by audiovisual, personal and methodological/motivational criteria or factors. We can also distinguish between generic and personal factors:
Generic factors (they do not depend on the particular person/user):
Generic audiovisual factors
Generic psychological/motivational factors
Other factors (technical, budgetary . . . ).
Personal factors: the user's input and later evolution/compliance can affect the future structure and composition of the Video-pill.

Briefly, each one of them is analyzed:
Generic audiovisual factors: the music and images of the video-pill are directed towards the achievement of a specific future emotional state. This emotional state is directly related to the audiovisual (film) construction of the video unit. And particularly to the following aspects:
   Structure of the “story”, from a cinematographic point of view, in its different phases: introduction, conflict and resolution (See FIG. 8.—Evolution of the user's Emotional State)
   Film editing and rhythm of each sequence
   Transition between the different elements
   Integration and fusion of personal elements (images, phrases, . . . ) in each sequence
   Integration of the music, as a powerful enhancer of the emotional state
Generic psychological/motivational factors: these psychological factors determine the Video-pill's “screenplay”: each one of the elements appearing in the video-pill, as well as the moment and frequency of their appearance, their importance and duration in the video-pill. An important aim is the user's identification with the character(s) of the Base-Video. Somehow, the user has to feel that the story and situations appearing in the video are his/her own story, his/her own reality, problems and vital objectives. As it was indicated in section number 3, brief description of the invention, the different elements appearing in the video-pill, according to said psychological and motivational criteria have to do with aspects such as: our dreams, personal commitments, our faith in success, our boosting or limiting beliefs, our determination with respect to decisions towards personal change, etc. That is, with all those elements which are somehow part of and are necessary in a process of transformation, personal change or achievement of objectives.
Personal factors: the user's personal characteristics can modify the selection, order and way of integration of the different elements. Particularly, the following aspects could somehow influence:
   The user's Audiovisual Sensitivity level (VAK and other aspects)
   Previous success and failure experiences
   Personal boosting and limiting beliefs
   His/her superficial and deep reasons to pursue the objective
   Aspects of their personality and behaviour patterns related to the objective pursued
   Degree of compliance with the visualization calendar
   Degree of compliance with the commitment/objective

b) Description of the BASIC ELEMENTS which Constitute the Video-Pill

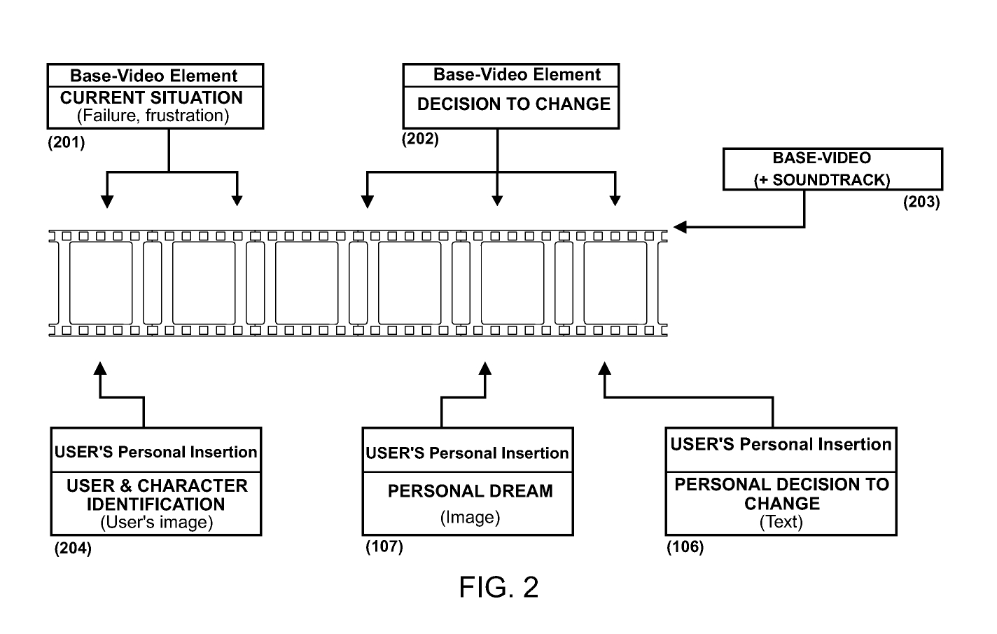

Video-pills are structured in 3 fragments or phases (as shown in FIGS. 2, 3 and 4), and, as it was indicated above, comprise 2 major types of elements:

Base-Video elements (114) which are specifically developed for each type of objective and/or quality of the personality to be developed. They are common to all users who use this video-pill, and preferably created from cinematographic production with its own soundtrack, created and adapted to each video-pill.

Personal elements os “personal insertions” (104): provided or selected by the user (images, phrases, voice recordings . . . ) and completely integrated in the Base-Video sequences.

These basic elements which form the Video-pills are the ones described below:

Elements of Fragment I of the Video-Pill: (As shown in FIG. 2)

Identification with the Character (204)

### User's Photograph/Personal Image (105) (Personal “Addition”)

For the user/client to identify him/herself with the character-actor of the audiovisual pill, a first sequence is needed in which there appear the client's image, which is “transformed”, “fused” or “introduced” in the character of the film, through some cinematographic transition effect (for example, a “morphing” or zoom-in and zoom-out effect into the user's and character's eyes, or alike).
From that moment, the user understands that it is s/he who is the main character of the story s/he is about to visualise.

Current Situation (201)

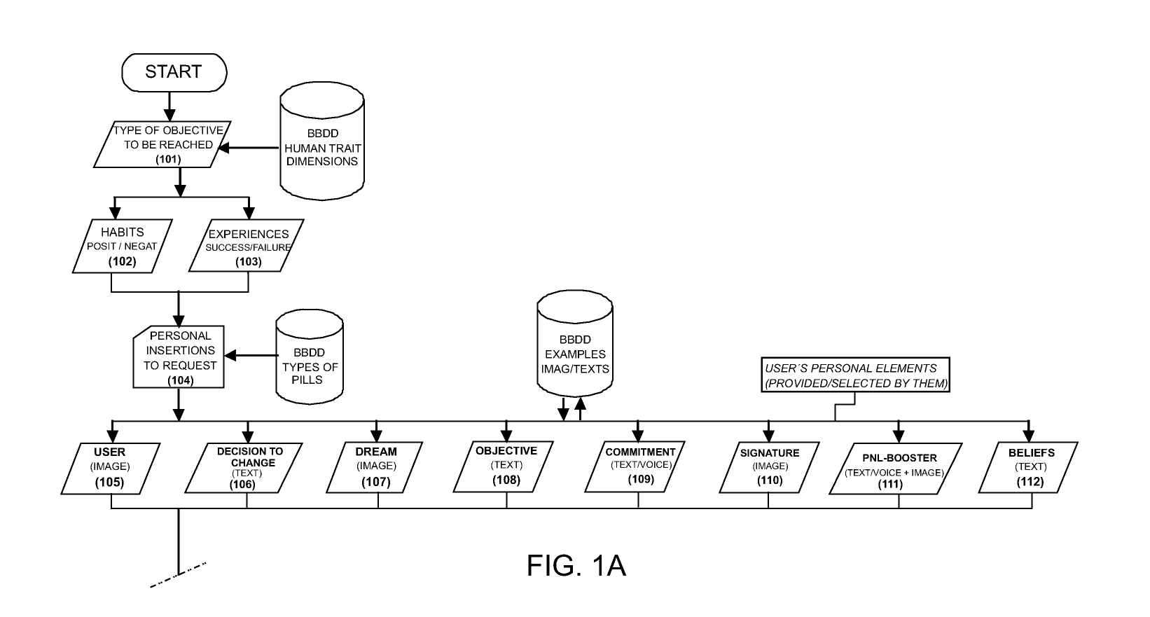

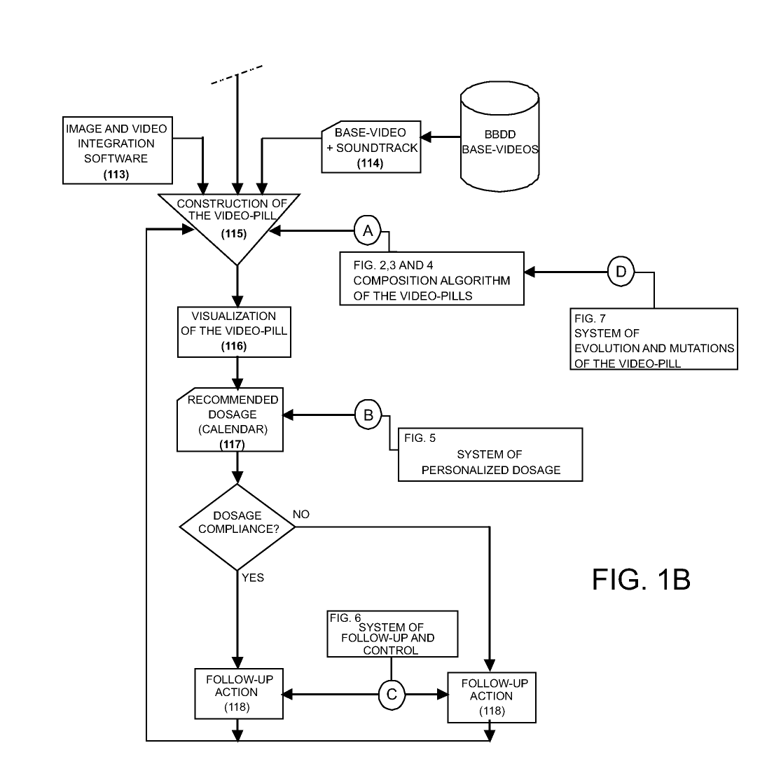

It's part of the Base-Video.
Video sequences which show different real situations of the character (2-5 different situations), as “flashbacks” or recollections of said character, presenting his/her current situation: those aspects which s/he does not like about his/her life, worries, failures or insecurities, in the specific dimension of his/her life which s/he does not like and wishes to change, like the client.
Superimposed phrases or metaphorical images can appear in these sequences to better explain the character's moment and situation.
The situations which appear in this sequence can be adapted and completely personalized according to the user's reality, since (see FIG. 1.—Diagram of the global Process) the user has previously inserted success or failure experiences related to this topic, or positive or negative habits on which s/he wishes to work.

Decision to Change (202)

It's part of the Base-Video.
The main character of the short film has an experience, sees something that makes him/her think and realizes that s/he needs an urgent and radical change in his/her life.
From that moment, s/he decides to change his/her life (in the dimension to which the video-pill refers to) and starts to act.
What the character sees in this video sequence are, at least, 2 elements which accidentally coincide in this instant:
A phrase of change, special and apparently casual, which powerfully catches the user's attention (because coincides with a personal phrase, provided or selected by the user).
A visual component, e.g. an image, apparently casual, but not casual at all: it also coincides with a personal image, provided or selected by the user.
   This decision towards a radical change in his/her life is visually shown in 2 ways: symbolically, with a signal (e.g. the “Y” for Yump) which represents the leap, the decision, the change; and we also see it in the character's state of mind, which is shown in a state of trust, responsibility, of knowing that s/he has finally chosen the correct path in his/her life.

Personal Decision to Change (106)

It's a Personal Insertion: Decision to Change (Personal Phrase (106) written by the user). That change phrase of the previous element, apparently casual, was actually the change phrase that the user him/herself personally added in the platform and which represents his/her very own decision to change.
This phrase is fused with and integrated into the film, making a casual and apparently unimportant element in the story, become a highly-impact and personalized element for the user. With this resource, the client's identification process with the character is also promoted. This element is integrated in the same sequence as the previous element (“Decision to change”).

Personal Dream (107)

It's a Personal Insertion: Personal Dream image (107) selected or provided by the user. The user has selected (or uploaded from his/her computer) one or several images which for him/her represent this Dream, this great Objective which represents what s/he wants to attain and which will be the symbol for this change in his/her life (it can also be an aspect or situation which s/he wants to avoid and which often motivates people even more to take decisions and act).
This is the 2nd element, apparently casual, which appeared in the “Decision to change” element, together with the Personal change Phrase. The almost simultaneous appearance of both elements pushes the character to become aware of the need for a deep change in his/her life.
This element is integrated in this sequence of the video-pill, although it will appear in several occasions along the character's story.

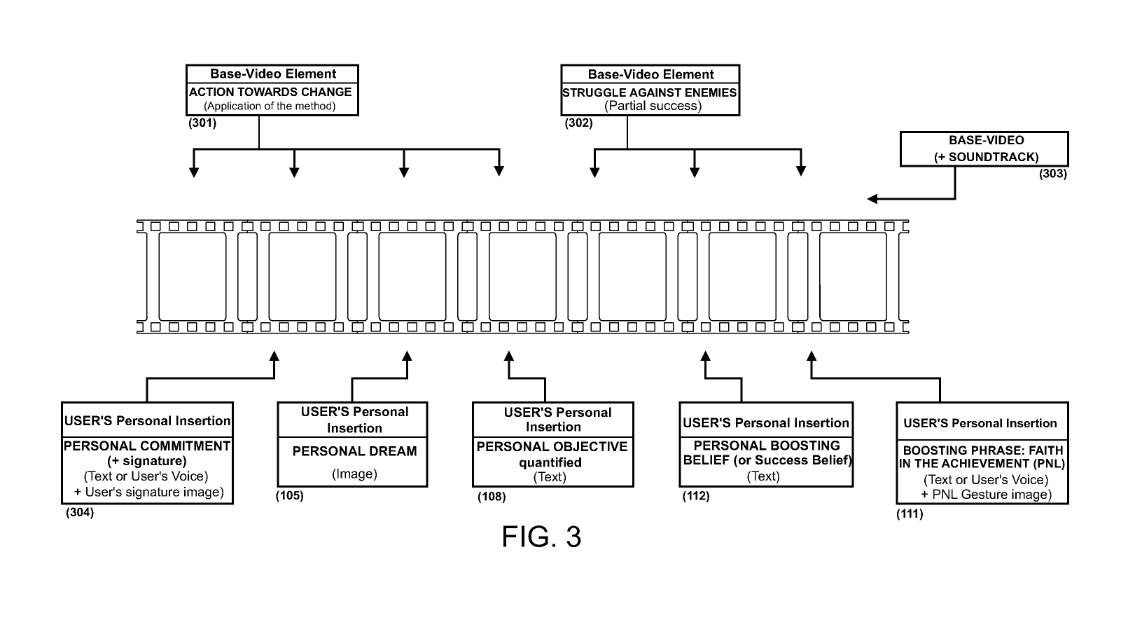

Elements of Fragment II of the Video-Pill (As Shown in FIG. 3)

Action Towards Change (301)

It's part of the Base-Video

The character starts actions which will support this great change in his/her life: s/he visualizes and writes down his/her Commitment, his/her specific Objectives and his/her great Dream.

Personal Commitment (304)

It's a Personal Insertion: Personal Commitment phrases (109)+Image of his/her signature (110)
This element shows an exercise that the user has previously done in the platform, in which s/he has committed him/herself to the success in his/her new resolution to change.
S/he has made a commitment with him/herself, with another person, with the final achievement and with the fulfillment of an Action Plan (which s/he has made before, in order to achieve his/her Objective).
This Commitment is reflected in a virtual written document signed by him/her (to that end an image with his/her signature will have been optionally loaded in the system).
This document will have an attractive and very personalized aspect. It will be perfectly visually integrated in the previous element, “Action towards change”.
It will be possible to read some important phrases of said document, or the user could also have previously recorded them and then his/her own voice will be played, with the Commitment document on the background.

Personal Dream (105)

New insertion of this element, in another sequence
The image of his/her personal Dream will appear again, but now it will be integrated in the character's new situation, moving into action.
It is perfectly visually integrated in the element “Action towards change”

Personal Objective (108)

It's a Personal Insertion: Phrase or figure which settles the user's personal objective (108)
In this sequence of “Action towards change” this client's new personal element appears, also completely integrated at the visual level.
This element represents the specific objective the client wishes to attain. It can be a sales objective, his/her ideal weight, a figure or a phrase of any kind. Something that represents in a very specific and non-visual way (and preferably quantified) the objective to be attained.

Struggle Against Enemies (302)

It's part of the Base-Video
Situations in which the character struggles trying to change, but cannot completely defeat his/her “enemies” are represented. They can be a bad habit, lack of trust, perseverance or courage . . .
The most common enemies will appear (generally personality defects), aiming the user's identification with some of them. We will know the user's specific enemies, so those will be emphasized.
The sensation to be transmitted is still hard and difficult, that of alternating between success and failures.

Success Belief or Boosting Belief (112)

It's a Personal insertion: Phrase summarising a Belief that helps to success achieving (112)
This phrase (selected from a list, or written by the user him/herself) represents the belief in success which the user most wants to emphasize, as it is closely related to the objective pursued, since it gives him/her special strength to continue, or because it is the aspect in which s/he has failed before (for example, phrases such as: “Failure is not trying”, “Success depends on me”, “I'm the captain of my destiny”. . . )
The letter “Y” appears again, as a symbol of change and of the decision to pursue the Objective, facing any enemy that might arise.
This element will be interspersed in the previous element “Struggle against enemies”.

Personal Anchoring (NLP) And Faith in Personal Accomplishment (111)

### NLP-Exercise Insertion: Image+Boosting Phrase (Faith in the Accomplishment) (111)

Among the optional and recommended activities for the user, a very basic NLP (Neuro-Linguistic Programming) exercise will be done. A simple exercise of visualization, emotion and repetition, in which the objective will be to fix in the user a belief in success. Specifically, this element will focus on the most important of all beliefs in success: Faith in that his/her Dream or final Objective will be attained in the end. This absolute certainty about the fact that s/he will achieve its objective is, by far, the most important of all beliefs for success.
This experience lived by the user, which is very intense emotionally, is associated to an “anchoring” element (it can be a gesture, an objective, or the simple memory of a situation or action), which will be inserted, as an image or video, in the sequence of the video-pill, so that the user remembers and relives this moment of special emotional intensity when s/he visualized his/her Dream and felt Faith and absolute certainty in its accomplishing.

Specifically, this anchoring will be added to the video-pill through the addition of a boosting phrase (a phrase selected by the user, such as: “Yes, I can”, “Now”, “Yes” or similar); as well as through the addition of a gesture (image or video sequence of for example a clenched fist) which transports the user to that sensation of Faith in the achievement. As part of the methodology, the user can be encouraged to actively participate in these phrases and gestures, with his/her own voice and movements.

With the video-pill and the later dosage plan, said anchoring will be totally promoted and its boosting effect will be maintained over time, since the 2 basic elements of neuron connection modification are involved: emotion and repetition.
This element will also be integrated in the element “Struggle against enemies”.
Faith in the achievement is the key element to help overcome the worst moments, those situations in which one is terribly pessimistic and it seems impossible to stay in the path towards success.

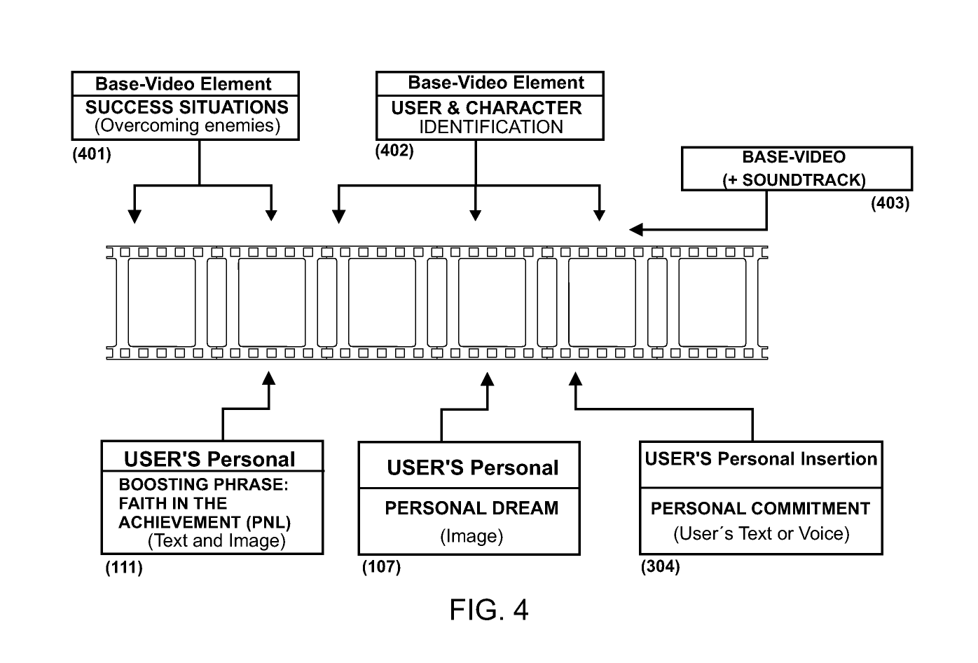

Elements of Fragment III of the Video-Pill (As shown in FIG. 4)

Success: overcoming one's enemies (401)

It's part of the Base-Video
Different situations are presented showing the character as s/he defeats his/her enemies: s/he successfully gives up a bad habit, dares to do something, undertakes small or big changes, is determined, positive and enthusiastic.
What is aimed at is the user's identification with these behaviours and emotional states, and therefore, imitation and “modelling” thereof. To that end, special emphasis is made on some of the client's specific “enemies”, which can be identified with the different situations experienced by the character.
In this part, it is essential to generate a maximum emotional state in the client. Music is fundamental in this phase of the video-pill.

Personal Success (111)

### It's a Personal Insertion: Image+Boosting Phrase (Faith in the Accomplishment) (111).

In this sequence of “Success”, the 2 elements of the previous fragment II of the video-pill appear again. Both phrases are totally inserted at a visual level

User-Character Identification (402)

### It's a Personal Insertion: Client's Photograph (105)

For the user/client to identify him/herself again with the character-actor of the video-pill, the initial effect of the video-pill is repeated, but in the opposite sense: now it is the film character who “transforms”, “fuses” or “introduces” him/herself in the client's image, through the same initial transition effect, but the other way around.

The person understands that all that has happened to the character in the story is actually his/her own reality, his/her own story of personal change.

Dream (107)+Personal Commitment (304)

### It's a Personal Insertion: Images of Personal Dream (107)+Personal Commitment (304)

In the final identification and impact process, the other 2 basic success engines appear again (integrated in an original way): the client's personal Dream (image) and the Personal Commitment (text and signature).
Both elements are integrated with the previous element (client's photograph).
Once more, the emotional load (visual and musical) is fundamental in this final sequence. An important aspect to keep in mind regarding the composition of each video-pill is that the duration of each element appearing in the audiovisual sequence is prefixed in advance. Regardless of the format and type of content, its duration will be already prefixed and, therefore, so will be the total duration of the video-pill.
This aspect is necessary for the music—integrated in the Base-Video—to be already composed and pre-recorded, adapting it to each psychological moment and each element of the pill.

c) Topics and Types of Video-Pills

As shown in FIG. 1 (Diagram of the continuous motivation process through personalized video-pills), the first election or input introduced by the user is the topic or Type of Objective s/he wishes to reach (101).
The range and type of video-pills will be determined by 2 inputs by the user:
Type of Objective to accomplish: professional, relational, physical, academic, sport-related . . .
Personality trait to be improved: self-trust, perseverance, optimism, resilience . . .
   Usually topics work on only one Dimension (or type of Objective) or on only one personality trait, although there can also be video-pills which work on several types of Objectives or several traits at a time. And it will work as a matrix: video-pills which work at the same time on one (or several) Objectives and on one (or several) personality traits.

Types of video-pills, according to the different types of Objectives to accomplish

The types of objectives (personal or professional) which can be pursued and which this methodology and its motivational pills can help achieve are virtually unlimited. However, the following is a list of possible preferred objectives, which can be accomplished with the motivational video-pills. The most important aspect of said list is their classification into three big groups, since among them there will be important differences at the level of algorithm and composition structure of the video-pills:

Mid-/Long-Term Objectives
Professional
   Career promotion
   Achievement of specific objectives in your position (e.g. business objectives)
   Entrepreneur with an operating company
   Setting up a new company
   Promotion or post changing
   Brand Engagement (directed to the company, for its employees)
Intellectual
   Order and control—Increased productivity
   Success in your studies/Competitions
   Work of art (e.g. writing a book)
   Learning a language
Relational
   Networking—Meeting people, making new friends
   Finding a partner (e.g. singles or separated people)
   Leadership
   Re-establish relationships
Physical
   Healthy eating
   Doing exercise
   Sport competition (e.g. handicap golf, marathon, . . . )
   Maintaining weight (or small weight loss)
   Considerable weight loss

Particular Emotional State (Right Before . . . ):
An exam (e.g., driving exam)
Dining out (in the case of weight loss)
A job interview
Public speaking
Dating
A sport competition (individual or team)
A meeting with clients

Creating Psychological Barriers (Risk Prevention, Elimination of Habits):
No junk food (or eliminate specific food)
No smoking
No drugs
No alcohol
No unprotected sex
No nail biting
Losing phobias and fears (without recovering them over time)
Permanent faithfulness

As it was indicated, maybe the most important aspect of this classification of video-pills is the structuring into these 3 big groups, as they will determine distinguishing aspects and elements in the algorithm, rhythm and duration of the different video-pills. In this sense, there will be important variations, according to whether mid- or long-term objectives are pursued; or if a particular emotional state is pursued (preparing us for a particular situation); or if one wishes to create a psychological barrier.

Types of video-pills, according to the different personality traits to work on A possible list of the basic personality traits for the achievement of the objectives would be the following:

Extrovert
Communicative
Sociable
Daring in a group
Spontaneous
Kind/warm

Sympathetic
Conciliatory
Trusting
Fair
Good-natured/Generous
Modest
Honest/Sincere/Upright
Loyal
Trustworthy/Reliable
Tolerant
Thankful

Emotionally Stable/Balanced
Objective/Impartial
Under control/Not reactive
Patient

Emotionally Strong
Resilient
Positive
Self-confident

Energetic
Active
Cheerful
Passionate

Open-Minded
Curious
Looking for a variety of experiences
Creative

Proactive/Full of Initiative
Decided
Enterprising
Brave

Goal-Focused
Ambitious
Self-discipline/Perseverance
Organized/Methodical
Precise/Consistent
Direct/Practical

d) System to Establish the Recommended DOSAGE: Dosage Unit (802)

The Dosage recommended to the user (117), which basically consists of a calendar with the frequency of visualization of the video-pill for the following weeks, is a fundamental part of the continuous motivation methodology through video-pills.
As with medicine, it is not enough to provide the ingredients of the pill, but also the daily “dosage” and the duration of the “treatment”.

Based on specific generic psychological and motivational criteria, a first basic dosage can be established, which is shared by all users. This recommended dosage includes aspects such as:
Duration, in days, for which the dosage is established
Daily visualization frequency
Optimum moments of the day for said visualization
   Analysing each one of these aspects in greater detail:
Duration (in days) of the period for which the dosage is going to be established: at first, the 3-week period (21 days) can be considered as a generic basic period for the duration of the different periods. Normally accepted in the scientific scope, it is the time the human mind needs to adapt itself and internally assume the important changes in the individual (psychological or even physical changes). Therefore, the dosage can comprise, a priori, successive periods of 21 days.
As regards the video-pill visualization daily frequency, in a first phase of change, the daily dosage should range between 1 and 3 times a day, according to the type of pill and the objective pursued. Later on, and as the user comes closer to or reaches his/her objective, the dosage will be reduced over time, generally, being possible to go from the initial 1-3 visualizations a day to a “maintenance” dosage, which would consist of the visualization of the video-pill once every couple of days (or even once every several weeks). However, on occasions greater maintenance reinforcement may be needed.
As regards the optimum moments for visualization during the day, they are preferably the following:
   First thing in the morning, since it is a receptive moment, when the person is rested and when s/he mentally visualises and faces the rest of the day
   At the end of the day (in the evening): period before the sleeping phase, when the thoughts and experiences lived throughout the day will settle
   At moments of calmness or rest, specially mental rest, when the mind is more receptive to receive messages and modifying behaviours

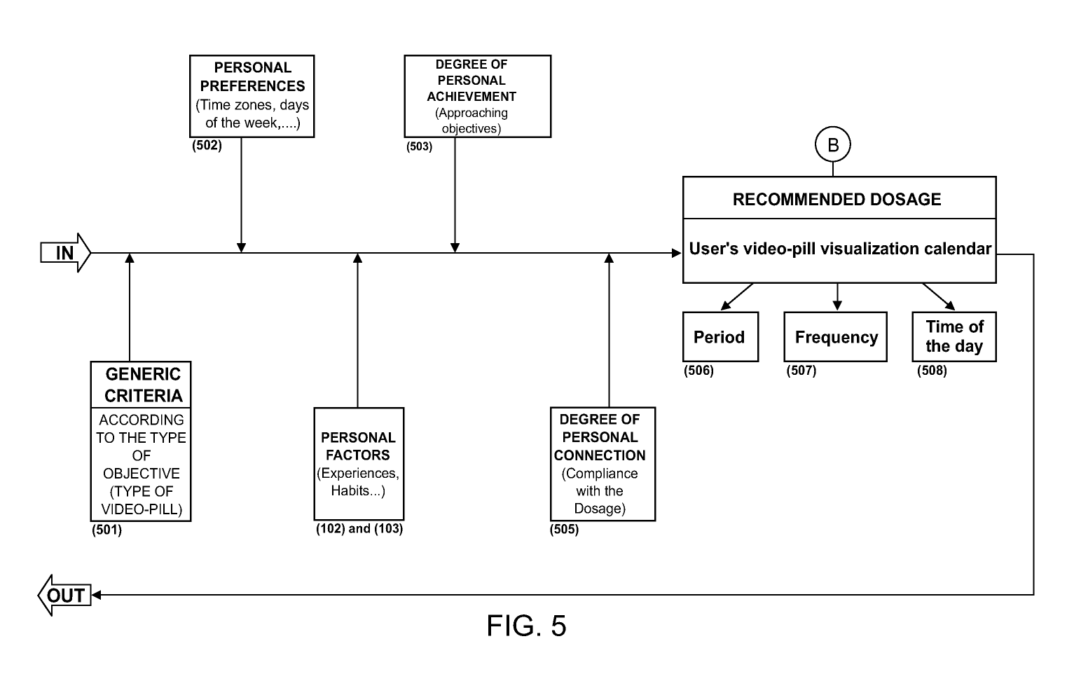

Besides these generic psychological aspects for all users, also according to the user's personal factors and situation, the dosage can be adapted, so that it is specific for each user. Particularly, and as shown in FIG. 5, the different basic inputs which form and determine the personalized visualization Dosage for each user are the following:
Previous Factors:
   Generic factors (501) common to all users, such as for example, the Type of video-pill (determined by the type of objective pursued, as well as by the human trait which is to be developed)
   The user's personal factors (504): specific aspects of the user's life and personality, which the platform will have stored in order to adapt the dosage to these factors (habits to be eliminated or modified, experienced had along the years, level of visual, auditory and kinesthetic (VAK) sensitivity, etc.)
   The user's personal preferences (502): mainly at the level of time availability, time zone limitations, days of the week, etc.
Compliance Factors:
   The user's degree of connection (505) (basically determined by the degree of compliance with the dosage recommended by the platform)
   Degree of personal achievement (503) (determined by the degree of compliance with his/her action plan and therefore, of approaching his/her objectives)
      As it was mentioned before, not only does the dosage evolve and adapts to each user's reality, but the video-pill composition formula also changes, producing small variations or “mutations” in the video-pills, with the purpose of producing in the user the psychological and motivational effects needed at each moment.

e) Follow-Up Unit (807): Control and Communication with the User

Another crucial aspect for the whole system to work and for the user to attain his/her goals is the System of Follow-up, control and communication.
It basically consists on the platform producing, in an automated way, a follow-up plan, based on daily reminders and motivational messages.
The objective is to maintain the user connected with him/herself and with his/her objectives, by being connected to the platform.
No matter how striking the video-pill is, or if the recommended dosage is the appropriate one, it is fundamental that the web platform can create this active and permanent communication with the user.

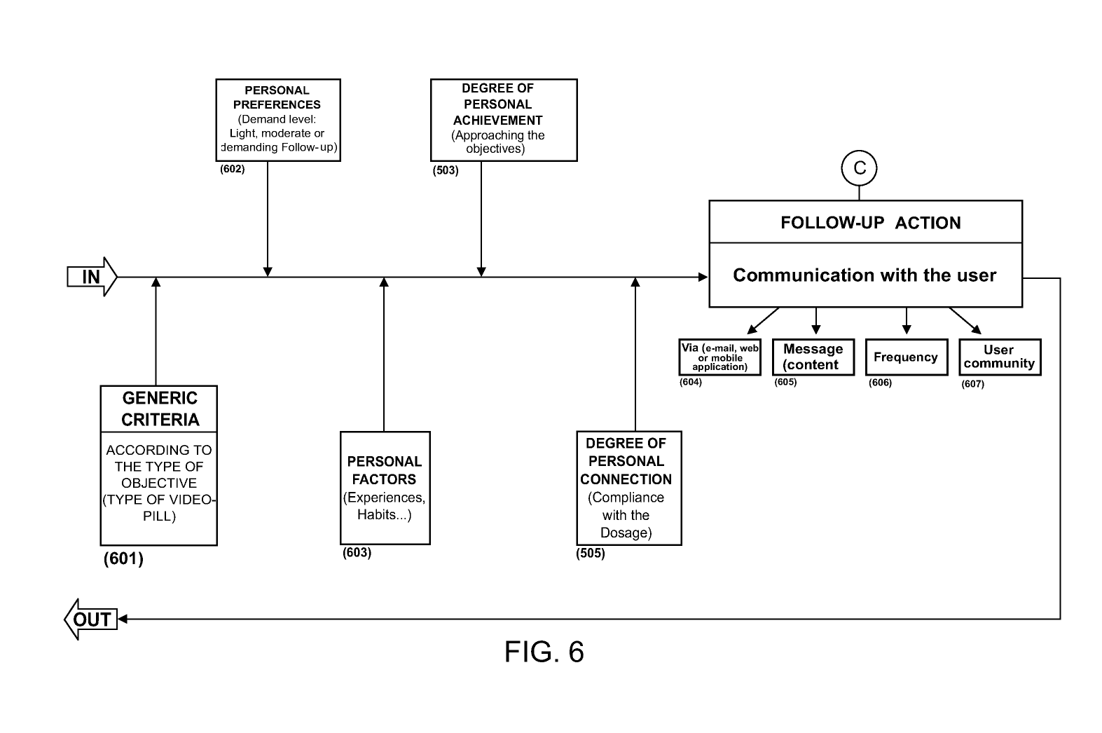

As it can be seen in FIGS. 6 and 8 (Follow-up Unit, control and communication in a personalized manner), to define this follow-up unit, it is recommended to define aspects such as:
The communication channels (604)
The content of said messages, as regards form and content itself (605)
The frequency of the messages (606)
TheUsers' Community (607)

Analysing each one of these aspects in greater detail:
Different communication channels (604) with the user can be used, getting the maximum use of new technologies available today. Specifically, preferred channels, due to their simplicity and low cost would be the following:
   e-mail (by far an excellent communication channel, immediate and low-cost)
   through messages received in the web platform (once the user has logged in)
   directly on the user's mobile phone, through an application specifically designed to receive messages from the web platform
As regards the content (605) of said messages, it is important that the objective of each message is well-defined and that they are appropriate for the user, according to the moment where s/he is at. Therefore, it is necessary to pay special attention to them, both as regards content and form:
   The content: the objective of the message can be very diverse, from support messages (through motivating and boosting messages), to reconnection messages, congratulations, reminders, etc. Personal content and information of high emotional impact for the user, such as his/her Dream, personal Commitment, etc. can be included.
   The form: aesthetic and design aspects of the message, including personal images, etc.
As regards the sending frequency (606), it will depend on the specific situation in which each user finds him/herself, but it is important to maintain a minimum communication frequency, of at least one message per day, or every 2 days. However, the user can establish a frequency pattern for the messages to be received, according to his/her tastes or personal needs.
Finally, the User's Community (607) specifically refers to using discussion and debate forums which will be generated on the web platform (with a different community for each one of the topics or types of video-pills), to generate multiple and powerful psychological effects in the user, which in turn will benefit and facilitate their connection with the platform, and therefore, their personal success:
   Identifying with other users and being aware of the fact that our problems are universal
   Taking advantage of experiences and modelling behaviour patterns of other users
   Giving examples to other users, sharing one's experiences and guidelines for success (generating in oneself feelings of contribution, leadership and self-esteem)
   Sharing one's small or big failures in the path towards ones objectives, to feel one is not alone on the path
   In short, keeping oneself connected to the platform and to oneself, through keeping in contact with friends and/or new relationships, who share one's objectives and come across the same obstacles

In the same way as in the unit to establish the most appropriate Dosage for each user, different basic inputs will be taken into account to establish the Follow-up unit, controlling and allowing communication in a personalized manner, as shown in FIG. 6:
Previous Factors:
   Generic factors (601) common to all users, such as the Type of video-pill
   The user's personal factors (603): habits to be eliminated or modified, experiences lived along the years . . .
   The user's personal preferences (602): the user can choose between several demand levels in the follow-up (light, moderate or demanding), which determines the frequency and content of the messages
Compliance Factors:
   The user's degree of “connection” (505) (the degree of compliance with the dosage recommended by the platform)
   Degree of personal achievement (503) (degree of compliance with his/her action plan and therefore, of approaching his/her objectives)

f) Evolution and Mutations of the Video-Pill: Evolution Unit (808)

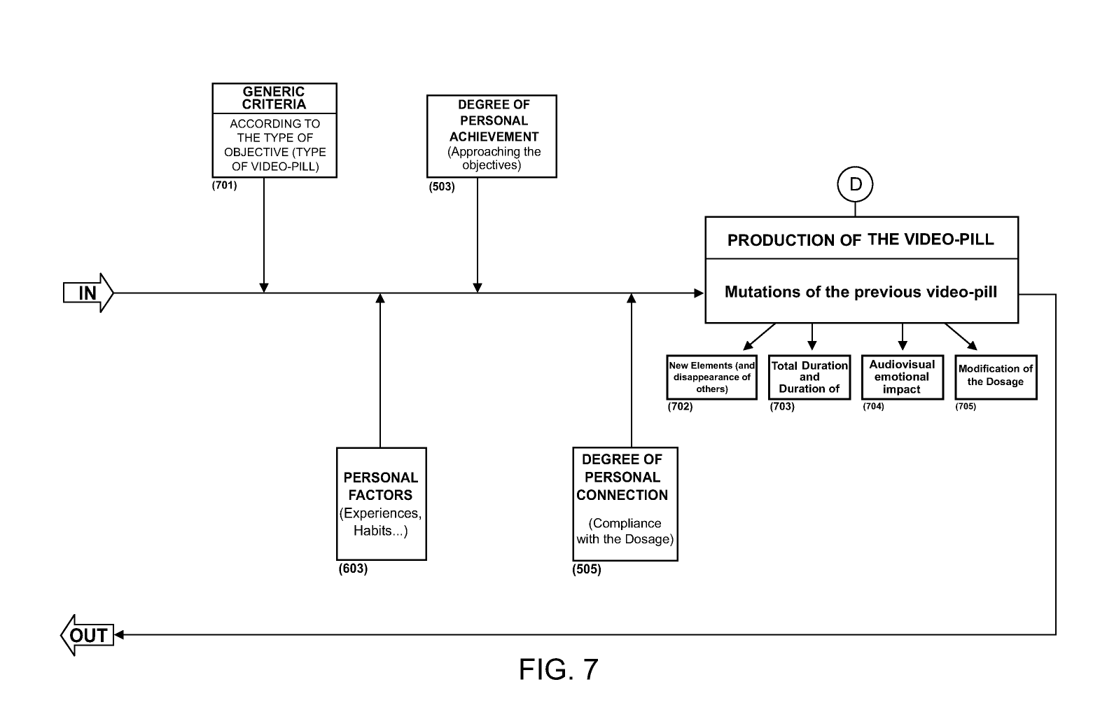

Another crucial aspect for the whole system to work and for the user to attain his/her goals is the System of Mutations and evolution of the video-pill.
The internal structure of the Video-Pill, which is defined by the algorithm, changes regularly or mutates over the time of the dosage.
These mutations occur automatically and continuously -weekly or monthly, and they determine, as it can be seen in FIGS. 7 and 8 (Evolution unit), from criteria and generic factors—for all users—or personal factors for each user.
Generic Criteria (701):
   Providing variety to the contents or to the way of showing them to the user, to make them more entertaining, thinking of a repetitive visualization over time
   Adaptation to a generic assimilation process: there are certain contents which it is necessary to emphasize more (due to a greater complexity in their assimilation) or less (because it is assumed that they are already assimilated)
Adaptation to the user's specific circumstances, which will be given by:
   His/her degree of connection (505) or compliance with the established dosage
   His/her degree of accomplishment of the objectives set (503)
   His/her previous experiences and difficulties (603) which s/he may have overcome or not

The most important mutations or changes which are made in the composition formula of the video-pill are:
New elements (702): the insertions or personal elements introduced by the user can all be used from the beginning, or they can be gradually inserted in the following mutations. Also, new personal elements can be requested to the user, in order to add them to the video-pill. These new elements can also be new fragments of the Base Video: new fragments or sequences added to the initial video-pill, which will be added over time, and during the dosage
Already inserted fragments or sequences, which are extended or shortened (703), or even eliminated in each new version of the video-pill
Change in the audiovisual emotional impact (704), for example, with modifications in the soundtrack
A change or mutation in the structure of the video-pill can imply a modification (705): also in the Dosage initially recommended to the user

In short, the object is a dynamic, lively, striking and effective video-pill from the psychological and motivational viewpoint. And to that end, it must be accompanied and surrounded by a methodology which is in accordance with it, also dynamic and in constant progress and evolution.

The aim of any video-pill (customized video) and of the accompanying continuous motivation methodology is to produce in the user such level of impact, repetition, entertainment, closeness to his/her results, group identification/feeling and motivation in general, that the probability of success in the achievement of any objective s/he sets is exponentially multiplied.

The various embodiments described above are provided by way of illustration only and should not be construed as limiting. Those skilled in the art will readily recognize various modifications and changes that may be made without following the example embodiments and applications illustrated and described herein.

What is claimed is:

1. A system for motivating a user to achieve goals comprising:
an interface configured to receive a first input of data regarding a goal to be achieved by the user, and user's personal information associated with said goal; the interfaz further configured to receive a second input of data regarding additional personal elements, said second input comprising at least an image representing the user;
a selecting unit configured to access to a storage unit storing a plurality of base videos, each base video having a descriptor indicating goal and theme, and to select a base video in dependence upon a comparison between the first input of data and descriptors of the base video;
an integration engine configured to integrate data selected from among the second input of data into a plurality of sequences of the base video whereby a customized video is produced;
a visualizing unit configured to visualize the customized video and to produce a visualization indicator in response to a performed visualization thereof

2. The computing system of claim 1, further comprising a dosage unit configured to establish a visualization calendar for organizing visualizations of the customized video in dependence upon the first input.

3. The computing system of claim 2, further comprising a follow-up unit configured to receive the visualization indicator and to establish a user's degree of compliance with the visualization calendar.

4. The computing system of claim 3, wherein the follow-up unit is further configured to send a message to the user, the message being prepared in dependence upon the user's degree of compliance.

5. The computing system of claim 3, further comprising an evolution unit configured to instruct the dosage unit to modify the visualization calendar in dependence upon the user's degree of compliance.

6. The computing system of claim 5, wherein the evolution unit is further configured to instruct the integration engine to introduce modifications of the customized video in dependence upon the user's degree of compliance with the visualization calendar.

7. The computing system of claim 2, wherein the dosage unit is further configured to set an action plan based on the first input of data, the action plan comprising a plurality of stages having an associated date range and an intermediate goal.

8. The computing system of claim 7, further comprising a follow-up unit configured to receive action plan information from the user and to produce, in response, a progress indicator for establishing a user's degree of compliance with the action plan.

9. A computer-implemented method for motivating a user to achieve goals, the method comprising:
receiving a first input of data regarding a goal to be achieved by the user and personal information related to said goal;
receiving a second input of data regarding personal elements, said second input comprising at least an image of the user;
selecting a base video from among a plurality of base videos having a descriptor indicating goal and theme, in dependence upon a comparison between the first input of data and descriptors of the base videos;
integrating data selected from among the second input of data in a plurality of sequences of the base video in order to produce a customized video;
visualizing the customized video,
producing a visualization indicator in response to a performed visualization.

10. The computer-implemented method of claim 9, wherein it further comprises setting a visualization calendar for organizing visualizations of the customized video in dependence upon the first input of data.

11. The computer-implemented method of claim 10, wherein it further comprises establishing a user's degree of compliance with the visualization calendar in dependence upon the visualization indicators.

12. The computer-implemented method of claim 11, further comprising sending a message to the user, the message being prepared in dependence upon the user's degree of compliance.

13. The computer-implemented method of claim 12, wherein it further comprises modifying the visualization calendar in dependence upon the user's degree of compliance.

14. The computer-implemented method of claim 13, wherein it further comprises modifying the customized video by introducing modifications in dependence upon the user's degree of compliance with the visualization calendar.

15. The computer-implemented method of claim 10, wherein it further comprises setting an action plan based on the first input of data, the action plan action plan comprising a plurality of stages having an associated date range and an intermediate goal.

16. The computer-implemented method of claim 15, wherein it further comprises, receiving action plan information from the user and producing, in response to said action plan information, a progress indicator for establishing a user's degree of compliance with the action plan.
